(19) United States
(12) Patent Application Publication
(10) Pub. No.: US 2026/0268197 A1
(43) Pub. Date: Sep. 10, 2026

(54) OBTAINING THE BEST NOISE FACTORS AND EXTRAPOLATOR TO BE USED IN QUANTUM ERROR MITIGATION

(71) Applicant: International Business Machines Corporation, Armonk, NY (US)

(72) Inventors: Ritajit Majumdar, Kolkata (IN); Dhiraj Madan, New Delhi (IN); Dhinakaran Vinayagamurthy, Erode (IN); Anupama Ray, Bangalore (IN)

(21) Appl. No.: 18/989,842

(22) Filed: Dec. 20, 2024

(51) Int. Cl. G06N 10/70; G06N 10/20; G06N 10/60

(52) U.S. Cl. CPC G06N 10/70; G06N 10/20; G06N 10/60

(57) ABSTRACT

A method, system and computer program product for performing quantum error mitigation. A machine learning model is trained to predict the optimal noise factors and optimal extrapolator to be used in quantum error mitigation based on the quantum circuits, such as the structures of the quantum circuits, and the selections of different quantum hardware (e.g., noise profile of the selected quantum hardware). Based on the received structure of a quantum circuit and the selected quantum hardware, the optimal noise factors and the optimal extrapolator to be used in quantum error mitigation for the received quantum circuit to be run on the selected quantum hardware are identified using the trained machine learning model. Quantum error mitigation is then performed on the quantum circuit, such as the received quantum circuit, after the quantum circuit has been run on the selected quantum hardware using the identified optimal noise factors and optimal extrapolator.

### TECHNICAL FIELD

The present disclosure relates generally to quantum error mitigation, and more particularly to obtaining the optimal noise factors and optimal extrapolator to be used in quantum error mitigation (e.g., zero noise extrapolation) to thereby obtain extrapolated expectation values close to the ideal expectation values.

### BACKGROUND

Quantum computing is a rapidly-emerging technology that harnesses the laws of quantum mechanics to solve problems too complex for classical computers. A quantum computer is a computer that exploits quantum mechanical phenomena. At small scales, physical matter exhibits properties of both particles and waves, and quantum computing leverages this behavior, specifically quantum superposition and entanglement, using specialized hardware that supports the preparation and manipulation of quantum states. Classical physics cannot explain the operation of these quantum devices, and a scalable quantum computer could perform some calculations exponentially faster than any modern “classical” computer.

### SUMMARY

In one embodiment of the present disclosure, a method for performing quantum error mitigation comprises training a machine learning model to predict noise factors and an extrapolator to be used in the quantum error mitigation based on structures of quantum circuits and selections of different quantum hardware. The method further comprises receiving a quantum circuit and a selection of quantum hardware. The method additionally comprises identifying noise factors and an extrapolator to be used in the quantum error mitigation for the quantum circuit using the trained machine learning model. Furthermore, the method comprises performing the quantum error mitigation on the quantum circuit after the quantum circuit has been run on the quantum hardware using the identified noise factors and the extrapolator.

Other forms of the embodiment of the method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for obtaining the optimal noise factors and optimal extrapolator to be used in quantum error mitigation techniques (e.g., zero noise extrapolation) for a given quantum circuit and quantum hardware in accordance with an embodiment of the present disclosure;

FIG. 3 illustrates an embodiment of the present disclosure of the hardware configuration of the classical computer which is representative of a hardware environment for practicing the present disclosure;

FIG. 4 is a flowchart of a method for selecting the optimal noise factors and optimal extrapolator to be used in quantum error mitigation techniques (e.g., zero noise extrapolation) for a given quantum circuit and quantum hardware in accordance with an embodiment of the present disclosure; and

FIG. 5 is a flowchart of a method for training the machine learning model to predict the optimal noise factors and the optimal extrapolator to be used in quantum error mitigation in accordance with an embodiment of the present disclosure.

### DETAILED DESCRIPTION

As stated above, quantum computing is a rapidly-emerging technology that harnesses the laws of quantum mechanics to solve problems too complex for classical computers. A quantum computer is a computer that exploits quantum mechanical phenomena. At small scales, physical matter exhibits properties of both particles and waves, and quantum computing leverages this behavior, specifically quantum superposition and entanglement, using specialized hardware that supports the preparation and manipulation of quantum states. Classical physics cannot explain the operation of these quantum devices, and a scalable quantum computer could perform some calculations exponentially faster than any modern “classical” computer.

Current quantum hardware, however, is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates.

As a result, quantum error mitigation techniques have been developed. Quantum error mitigation refers to mitigating computation errors while keeping the hardware load to a minimum. That is, quantum error mitigation is a technique that reduces the effects of noise and error on measured observables.

An example of a quantum error mitigation technique is the zero noise extrapolation technique. Zero noise extrapolation is a technique used in quantum computing to estimate the result of a quantum computation without noise by running the computation at different levels of added noise and then extrapolating the results to the “zero-noise” limit, effectively mitigating errors caused by the inherent noise in a quantum system. Such a technique utilizes parameters, such as noise factors and an extrapolator, to extrapolate the noisy results back to the zero-noise limit. Noise factors refer to the number of times the gates are folded, or in other words, repeated, to create a functionally equivalent quantum circuit which will be more noisy than the original quantum circuit due to the additional inserted gates. An extrapolator refers to a mathematical function used to estimate the ideal result of a quantum computation by fitting a curve through various expectation values obtained via the artificially amplified noise, i.e., the folded quantum circuits, and extrapolating to the zero-noise limit.

Unfortunately, there is no well-defined protocol to select the optimal noise factors and extrapolator such that they obtain the extrapolated expectation value (estimated ideal expectation value of a quantum circuit) that is close to the ideal expectation value (expected value of an observable that would be obtained in a completely noise-free quantum system).

As a result, selection of the optimal noise factors and extrapolator often depend on user experience and intuition. For example, one such technique runs the quantum error mitigation technique on randomized benchmarking quantum circuits and obtains the best set of noise factors and the best extrapolator to use for such quantum circuits. Such parameters may then be used for the quantum circuits of interest. Unfortunately, it is not guaranteed that such parameters, which are best suited for the randomized benchmarking quantum circuits, will also be the best parameters for any other quantum circuit. Furthermore, the noise factors are preselected from sets of noise factors which may not correspond to the optimal noise factors to be used in performing quantum error mitigation on a quantum circuit.

Another technique in an attempt to obtain the optimal noise factors and optimal extrapolator to be used in quantum error mitigation techniques utilizes a heatmap which stores the best extrapolator for a given noise factor with varying number of qubits and error probability. Unfortunately, the noise factors are preselected from a predefined set which may not correspond to the optimal noise factors to be used in performing quantum error mitigation on a quantum circuit. Furthermore, the technique requires the storing of the heatmap as a lookup table. Such a lookup table should be stored for different circuit types, which may require a significant amount of storage overhead.

Consequently, there is not currently a means for selecting the optimal noise factors and optimal extrapolator to be used in quantum error mitigation techniques (e.g., zero noise extrapolation) for a given quantum circuit and quantum hardware such that the obtained extrapolated expectation value is close to the ideal expectation value.

The embodiments of the present disclosure provide the means for selecting the optimal noise factors and optimal extrapolator to be used in quantum error mitigation techniques (e.g., zero noise extrapolation) for a given quantum circuit and quantum hardware such that the obtained extrapolated expectation value is close to the ideal expectation value using a reinforcement learning approach. In one embodiment, a machine learning model is trained, such by using reinforcement learning, to predict the optimal noise factors and optimal extrapolator to be used in quantum error mitigation (e.g., zero noise extrapolation, probabilistic error amplification) based on the structures of quantum circuits (e.g., number of qubits, number of 2-qubit gates, 2-qubit depth, etc.) and selections of different quantum hardware (e.g., noise profile of the selected quantum hardware, which may include data, such as calibration data, etc.). After training the machine learning model to predict the optimal noise factors and the optimal extrapolator, the noise factors and an extrapolator to be used in quantum error mitigation are identified using the trained machine learning model for the quantum circuit to be run on a selected quantum hardware based on the structure of the quantum circuit (e.g., number of qubits, number of 2-qubit gates, 2-qubit depth, etc.) and the selected quantum hardware (e.g., noise profile of the selected quantum hardware, which may include data, such as calibration data, etc.). Quantum error mitigation (e.g., zero noise extrapolation, probabilistic error amplification) is then performed on the quantum circuit after the quantum circuit has been run on the quantum hardware using the predicted optimal noise factors and the optimal extrapolator. In this manner, the optimal noise factors and optimal extrapolator to be used in quantum error mitigation techniques (e.g., zero noise extrapolation) for a given quantum circuit and quantum hardware such that the obtained extrapolated expectation value is close to the ideal expectation value can be obtained. These and other features will be discussed in further detail below.

In some embodiments of the present disclosure, the present disclosure comprises a method, system and computer program product for performing quantum error mitigation. In one embodiment of the present disclosure, a machine learning model is trained to predict the optimal noise factors and optimal extrapolator to be used in quantum error mitigation (e.g., zero noise extrapolation, probabilistic error amplification) based on the quantum circuits, such as the structures of the quantum circuits, and the selections of different quantum hardware (e.g., noise profile of the selected quantum hardware, which may include data, such as calibration data, etc.). In one embodiment, such a machine learning model is trained using a reinforcement learning approach. Based on the received structure of the quantum circuit (e.g., number of qubits, number of 2-qubit gates, 2-qubit depth, etc.) and the selected quantum hardware (e.g., noise profile of the selected quantum hardware, which may include data, such as calibration data, etc.), the optimal noise factors and the optimal extrapolator to be used in quantum error mitigation for the received quantum circuit to be run on the selected quantum hardware are identified using the trained machine learning model. The term “optimal,” as used herein, refers to those noise factors and extrapolator to be used for the quantum error mitigation technique (e.g., zero noise extrapolation), where such noise factors and extrapolator provide the extrapolated expectation value that is close to the ideal expectation value. Quantum error mitigation is then performed on the quantum circuit, such as the received quantum circuit, after the quantum circuit has been run on the selected quantum hardware using the identified optimal noise factors and optimal extrapolator. In this manner, the optimal noise factors and optimal extrapolator to be used in quantum error mitigation techniques (e.g., zero noise extrapolation) for a given quantum circuit and quantum hardware such that the obtained extrapolated expectation value is close to the ideal expectation value can be obtained.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

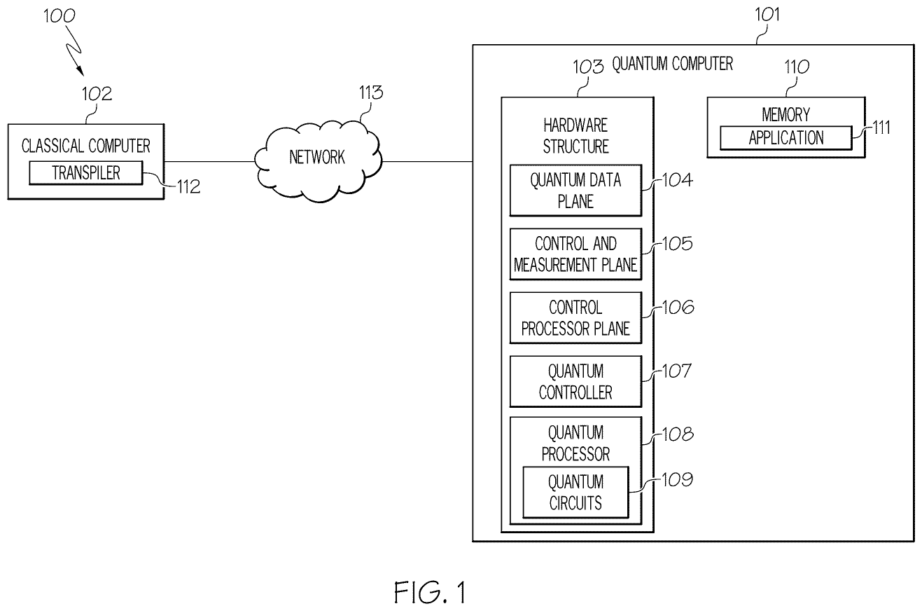

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to obtain the optimal noise factors and optimal extrapolator to be used in quantum error mitigation techniques (e.g., zero noise extrapolation) for a given quantum circuit and quantum hardware.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits'state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (also identified as Rx) (performs e^{-iθX/2}, which corresponds to a rotation of the qubit state around the X-axis by the given angle theta θ on the Bloch sphere), RY (also identified as Ry) (performs e^{-iθY/2}, which corresponds to a rotation of the qubit state around the Y-axis by the given angle theta θ on the Bloch sphere), RXX (performs the operation e^{-iθX⊗X/2}) on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

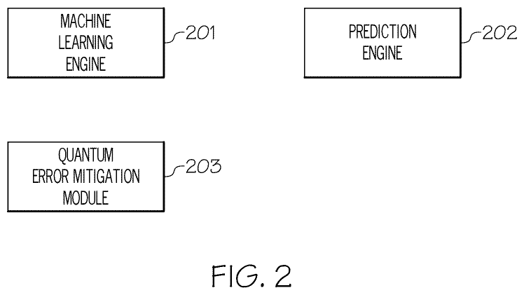

In one embodiment, memory 110 stores an application 111 that may be configured to implement one or more of the methods described herein in accordance with one or more embodiments. For example, application 111 may implement a program for obtaining the optimal noise factors and optimal extrapolator to be used in quantum error mitigation techniques (e.g., zero noise extrapolation) for a given quantum circuit and quantum hardware as discussed further below in connection with FIGS. 2 and 4-5. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit. transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters, and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features) * (number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

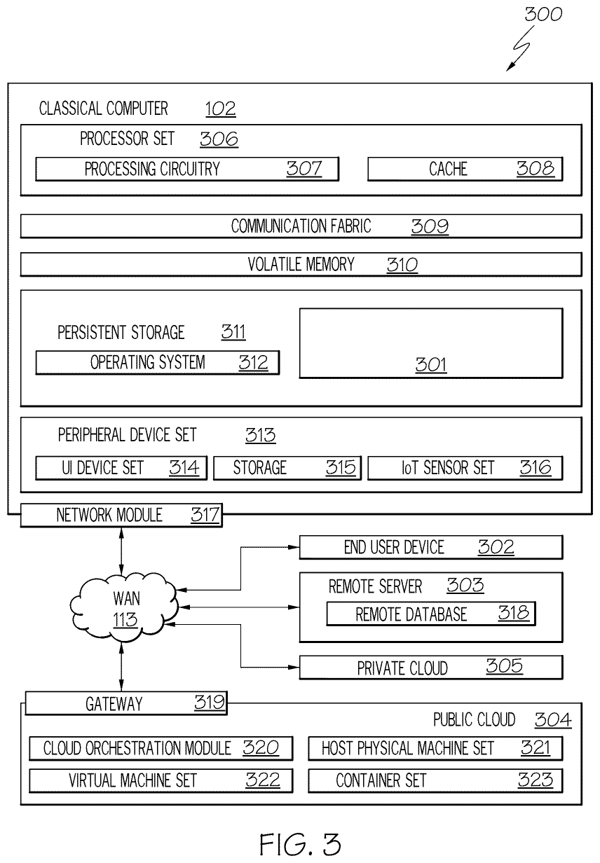

Furthermore, classical computer 102 is configured to obtain the optimal noise factors and optimal extrapolator to be used in quantum error mitigation techniques (e.g., zero noise extrapolation) for a given quantum circuit and quantum hardware as discussed further below in connection with FIGS. 2 and 4-5. A description of the software components of classical computer 102 is provided below in connection with FIG. 2 and a description of the hardware configuration of classical computer 102 is provided further below in connection with FIG. 3.

System 100 is not to be limited in scope to any one particular network architecture. System 100 may include any number of quantum computers 101, classical computers 102, and networks 113.

A discussion regarding the software components used by classical computer 102 for obtaining the optimal noise factors and optimal extrapolator to be used in quantum error mitigation techniques (e.g., zero noise extrapolation) for a given quantum circuit and quantum hardware is provided below in connection with FIG. 2.

FIG. 2 is a diagram of the software components of classical computer 102 (FIG. 1) for obtaining the optimal noise factors and optimal extrapolator to be used in quantum error mitigation techniques (e.g., zero noise extrapolation) for a given quantum circuit and quantum hardware in accordance with an embodiment of the present disclosure.

Referring to FIG. 2, in conjunction with FIG. 1, classical computer 102 includes machine learning engine 201 configured to train a machine learning model to predict the optimal noise factors and optimal extrapolator to be used in quantum error mitigation (e.g., zero noise extrapolation, probabilistic error amplification) based on the quantum circuits, such as the structures of the quantum circuits, and the selections of the different quantum hardware (e.g., noise profile of the selected quantum hardware, which may include data, such as calibration data, etc.).

In one embodiment, machine learning engine 201 trains the machine learning model to predict the optimal noise factors and optimal extrapolator to be used in quantum error mitigation using a reinforcement learning approach. In such an approach, machine learning engine 201 creates a pool of noise factors. A noise factor, as used herein, refers to the number of times a quantum circuit is folded, such as by repeating a certain gate sequence several times, which effectively increases the noise level by repeating parts of the quantum circuit. A pool of noise factors, as used herein, refers to a collection of different noise factors, each corresponding to a distinct “folding” or repetition pattern within the quantum circuit.

In one embodiment, machine learning engine 201 obtains such a pool of noise factors from an expert, which identifies all possible sources of noise within a quantum computing hardware considering factors, such as, the physical environment, control electronics, the design of the qubits, etc., thereby effectively taking into account the “folding” effect of repeated gate sequences. Furthermore, the types of noise are categorized based on their behavior, such as bit-flip noise (where a qubit randomly flips between states), phase-flip noise (where the phase of a qubit changes), etc. Additionally, each noise source may be represented using mathematical models, which may involve probability distributions and quantum operations, to describe how the noise source affects the state of the qubit.

In one embodiment, machine learning engine 201 creates such a pool of noise factors by characterizing the dominant noise sources on various quantum hardware. In one embodiment, machine learning engine 201 characterizes the dominant noise sources on various quantum hardware using various software tools, such as, but are not limited to, Qiskit® Ignis, Cirq®, Amazon Braket®, HQS® Noise App from HQS Quantum Simulations®, etc. In one embodiment, machine learning engine 201 then systematically generates a set of quantum circuits that amplify different combinations of these noise types to varying degrees, such as by manipulating gate durations, adding additional gates to introduce specific noise, or utilizing a noise model to simulate different noise scenarios. In one embodiment, machine learning engine 201 generates a set of quantum circuits that amplify different combinations of these noise types to varying degrees using various software tools, such as, but are not limited to, Qiskit®, Cirq®, PennyLane®, Amazon Braket®, etc.

In one embodiment, machine learning engine 201 creates a set of extrapolators (extrapolation functions). An extrapolator, as used herein, refers to a mathematical function used to estimate the ideal result of a quantum computation by fitting a curve through various expectation values obtained via the artificially amplified noise, i.e., the folded quantum circuits, and extrapolating to the zero-noise limit. Examples of extrapolators include, but are not limited to, linear, any degree of polynomial (e.g., quadratic polynomial), exponential, etc.

In one embodiment, machine learning engine 201 creates a set of extrapolators by defining a family of extrapolation functions that represent different noise levels. In one embodiment, such a family of extrapolation functions may be defined by scaling the noise in a quantum circuit and then fitting a curve to the results obtained at each noise level to extrapolate to the zero-noise limit.

In one embodiment, machine learning engine 201 scales the noise in a quantum circuit by applying a scaling factor to the noise parameters or using a “folding” technique to replicate noise multiple times. The “folding” technique, as used herein, refers to repeatedly running the quantum circuit and its inverse thereby amplifying the noise present within the circuit by essentially “folding” the noise onto itself allowing for better characterization and extrapolation to a zero-noise scenario.

In one embodiment, after scaling the noise in a quantum circuit, machine learning engine 201 selects a family of extrapolation functions (e.g., quadratic polynomial, linear, etc.) to fit the noisy measurements at different noise levels. Machine learning engine 201 may then generate noisy data by running the quantum circuit at different noise levels using a chosen scaling method thereby collecting the measured expectation values at each level.

In one embodiment, machine learning engine 201 fits the curve to the results obtained at each noise level to extrapolate to the zero-noise limit. For example, machine learning engine 201 may utilize the least squares regression algorithm to fit the noisy measurements to the extrapolation function thereby obtaining the best fit parameters for each noise level. Machine learning engine 201 may then evaluate each extrapolation function at the zero-noise point to obtain the extrapolated noise-free expectation value.

Furthermore, in one embodiment, machine learning engine 201 removes the noise factor(s) from the pool of noise which increase the depth of a folded quantum circuit beyond a threshold amount, which may be user-designated.

In one embodiment, machine learning engine 201 performs a pre-screening on the pool of noise factors in order to reduce the number of noise factors in the pool so as to ensure that the size of the pool of noise factors is finite and ensure that the signal can be retrieved from the folded quantum circuit. The folded quantum circuit, as used herein, refers to the quantum circuit that was mirrored or “folded back on itself” by repeating its operations in reverse order using the “circuit folding” technique discussed above.

In one embodiment, machine learning engine 201 pre-screens the pool of noise factors for each input quantum circuit to create a finite pool P of noise factors. For example, for a given quantum hardware, the depth of the folded quantum circuits is restricted such that d_{2q}·t_{2q}≤ƒ·T₁, where d_{2q} equals the 2-qubit depth of the quantum circuit, t_{2q} equals the execution time of a 2-qubit gate, ƒ is the fidelity of the quantum gate, T₁ represents the relaxation time of the qubit, and 0<ƒ≤1, where 1 indicates perfect fidelity. In one embodiment, machine learning engine 201 may then remove those noise factors from the pool of noise factors with values that do not satisfy such an inequality.

In one embodiment, machine learning engine 201 trains the machine learning model, such as via reinforcement learning, to select a set of noise factors from the pool of noise factors and select an extrapolator from the set of extrapolators based on the structures of quantum circuits and selections of different quantum hardware (e.g., noise profile of the selected quantum hardware, which may include data, such as calibration data, etc.). The structure of a quantum circuit, as used herein, refers to the model for quantum computations, which is represented as a sequence of quantum gates applied to qubits. Examples of the structure of the quantum circuit used in training the machine learning model include, but are not limited to, the number of qubits, number of 2-qubit gates, 2-qubit depth, etc.

In one embodiment, the trained machine learning model is a reinforcement learning model. In one embodiment, machine learning engine 201 trains the machine learning model to calculate an extrapolated expectation value, where a reward is granted to a reinforcement learning agent proportional to a distance from the extrapolated expectation value to an ideal expectation value. The extrapolated expectation value, as used herein, refers to the estimated ideal expectation value of the quantum circuit, which may be computed using the selected noise factors and a selected extrapolator. The ideal expectation value, as used herein, refers to the expected value of an observable that would be obtained in a completely noise-free quantum system.

In one embodiment, machine learning engine 201 obtains the ideal expectation value by Cliffordizing the quantum circuit used in training the machine learning model, where the ideal expectation value is calculated from the Cliffordized quantum circuit. Cliffordizing, as used herein, refers to rewriting the quantum circuit so that it only contains Clifford gates.

In one embodiment, machine learning engine 201 calculates the ideal expectation value from the Cliffordized quantum circuit by decomposing the desired observable into a sum of Pauli operators. The Cliffordized quantum circuit is then simulated by expressing the evolved operator as a linear combination of Pauli strings. The ideal expectation value is then calculated by taking the appropriate weighted sum of the Pauli string expectation values.

Alternatively, in one embodiment, machine learning engine 201 obtains the ideal expectation value by mirroring the quantum circuit used in training the machine learning model. “Mirroring,” as used herein, refers to creating a new quantum circuit by essentially reversing the operations of the original quantum circuit thereby effectively performing the same calculations in reverse order. In one embodiment, machine learning engine 201 runs the original quantum circuit forward and then runs the mirrored quantum circuit backward applying the desired observable operator in between. The resulting state is then measured to obtain the ideal expectation value.

Machine learning engine 201 utilizes various software tools for obtaining the ideal expectation value in the manners discussed above, including, but are not limited to, Qiskit®, Cirq®, PyQuil, QSim, ProjectQ, PennyLane®, etc.

In one embodiment, machine learning engine 201 trains the machine learning model to select a set of noise factors from the pool of noise factors and select an extrapolator from the set of extrapolators based on the structures of quantum circuits and selections of different quantum hardware using reinforcement learning using the following state space, action set and reward. The state space, as used herein, refers to the set of all possible states that an agent (reinforcement learning agent, which is a software program that learns to make decisions by interacting with its environment through trial and error using a system of rewards and punishments to gradually improve its actions and achieve a specific goal) can be in within a given environment.

In one embodiment, the state space S includes a collection of a set of pools of noise factors P'⊆P. Furthermore, in one embodiment, the state space S includes a set of extrapolators E, or a predefined extrapolator e.

In one embodiment, the action set A, corresponding to the possible actions that the reinforcement learning agent can perform in a given environment, include choosing a pool of noise factors from P′ and updating the extrapolator if required in the next fold in the folded quantum circuit. Furthermore, an action could be to select λ∈P and e∈E at each step, where λ corresponds to the number of folds in the folded quantum circuit.

In one embodiment, the minimum number of folds is determined by the degree of the extrapolator. In one embodiment, the maximum number of folds that can be used can be enforced from the allowed quantum overhead for performing quantum error mitigation, which may be user-designated or a default value.

In one embodiment, once the λs are selected, extrapolation can be performed in a sorted order.

In one embodiment, the reward, which corresponds to a numerical value that the reinforcement learning agent receives after taking an action in a specific state of an environment, corresponds to (ideal-predicted)²−ƒ(N) at the end of an episode, where N is the number of λ values selected. In one embodiment, the function ƒ can be chosen to increase with N to limit the number of foldings.

In one embodiment, machine learning engine 201 trains the machine learning model (e.g., reinforcement learning model) to predict the best noise factors upon being provided the extrapolator as opposed to predicting the optimal noise factors and the optimal extrapolator based on the structure of the quantum circuit (e.g., number of qubits, number of 2-qubit gates, 2-qubit depth, etc.) and the selected quantum hardware (e.g., noise profile of the selected quantum hardware, which may include data, such as calibration data, etc.). Such predicted noise factors and extrapolator correspond to the optimal noise factors and optimal extrapolator as discussed herein.

In one embodiment, machine learning engine 201 trains the machine learning model to predict the optimal noise factors for the provided extrapolator, where a reward is granted to a reinforcement learning agent proportional to a distance from the extrapolated expectation value (computed using the predicted noise factors and the provided extrapolator) to an ideal expectation value.

Classical computer 102 further includes prediction engine 202 configured to identify the optimal noise factors and the optimal extrapolator to be used in quantum error mitigation for a received quantum circuit (e.g., number of qubits, number of 2-qubit gates, 2-qubit depth, etc.) to be run on a selected quantum hardware (e.g., noise profile of the selected quantum hardware, which may include data, such as calibration data, etc.) using the trained machine learning model.

In one embodiment, prediction engine 202 receives a quantum circuit, such as the structure of a quantum circuit (e.g., number of qubits, number of 2-qubit gates, 2-qubit depth, etc.) for which to perform quantum error mitigation. In one embodiment, such a quantum circuit is provided to prediction engine 202 via the user interface of classical computer 102. In one embodiment, the quantum circuit, such as the structure of the quantum circuit, is inputted to prediction engine 202 via various software tools, including, but are not limited to, Qiskit®, IBM Quantum® Platform, Intel® Quantum Simulator, etc.

In one embodiment, prediction engine 202 receives a selected quantum hardware (e.g., noise profile of the selected quantum hardware, which may include data, such as calibration data, etc.), such as a quantum hardware selected from a menu of various types of quantum hardware. In one embodiment, such a menu of various types of quantum hardware is displayed to a user via the user interface of classical computer 102. The user may then select one of the types of quantum hardware being displayed to the user, such as via a mouse, tapping on a touchscreen, voice commands, keyboard, etc. In one embodiment, the selected quantum hardware (noise profile of the selected quantum hardware, which may include data, such as calibration data, etc.) is inputted to prediction engine 202 via various software tools, including, but are not limited to, Qiskit®, IBM Quantum® Platform, Intel® Quantum Simulator, etc.

In one embodiment, based on the provided structure of the quantum circuit and the selected quantum hardware, prediction engine 202 identifies the optimal noise factors and the optimal extrapolator to be used in quantum error mitigation for the received quantum circuit to be run on the selected quantum hardware using the trained machine learning model as discussed above. The term “optimal,” as used herein, refers to those noise factors and extrapolator to be used for the quantum error mitigation technique (e.g., zero noise extrapolation), where such noise factors and extrapolator provide the extrapolated expectation value that is close to the ideal expectation value.

Alternatively, in one embodiment, prediction engine 202 receives an extrapolator. An extrapolator, as used herein, refers to a mathematical function used to estimate the ideal result of a quantum computation by fitting a curve through various expectation values obtained via the artificially amplified noise, i.e., the folded quantum circuits, and extrapolating to the zero-noise limit. Examples of extrapolators include, but are not limited to, linear, any degree of polynomial (e.g., quadratic polynomial), exponential, etc.

In one embodiment, prediction engine 202 receives the extrapolator for which to perform quantum error mitigation. In one embodiment, the extrapolator is provided to prediction engine 202 via the user interface of classical computer 102. In one embodiment, the extrapolator is inputted to prediction engine 202 via various software tools, including, but are not limited to, Qiskit®, IBM Quantum® Platform, Intel® Quantum Simulator, etc.

In such an embodiment, prediction engine 202 predicts the best noise factors for that extrapolator using the trained machine learning model as discussed above. Such noise factors and extrapolator correspond to the optimal noise factors and optimal extrapolator discussed herein.

Classical computer 102 additionally includes quantum error mitigation module 203 configured to perform quantum error mitigation on the quantum circuit, such as the received quantum circuit, after the quantum circuit has been run on the selected quantum hardware using the identified optimal noise factors and optimal extrapolator.

Quantum error mitigation, as used herein, refers to mitigating computation errors while keeping the hardware load to a minimum. That is, quantum error mitigation is a technique that reduces the effects of noise and error on measured observables.

An example of a quantum error mitigation technique is the zero noise extrapolation technique. The zero noise extrapolation, as used herein, is a technique used in quantum computing to estimate the result of a quantum computation without noise by running the computation at different levels of added noise and then extrapolating the results to the “zero-noise” limit, effectively mitigating errors caused by the inherent noise in a quantum system.

Another example of a quantum error mitigation technique is the probabilistic error amplification. Probabilistic error amplification, as used herein, is a technique which introduces controlled noise to a quantum circuit to amplify existing errors. The amplified noise data is then used in conjunction with zero noise extrapolation, where the results from different noise levels are extrapolated to estimate what the results would be in a completely noise-free scenario.

Quantum error mitigation module 203 utilizes various software tools for performing quantum error mitigation in the manner discussed above, including, but are not limited to, Mitiq, Qiskit®, Cirq®, PyQuil®, etc.

In this manner, the optimal noise factors and optimal extrapolator to be used in quantum error mitigation techniques (e.g., zero noise extrapolation) for a given quantum circuit and quantum hardware such that the obtained extrapolated expectation value is close to the ideal expectation value can be obtained. Such optimal noise factors are not obtained from a search space that is restricted to a predefined list of noise factors. Furthermore, embodiments of the present disclosure do not require the storing of a heatmap as a lookup table thereby avoiding such a storage overhead.

A further description of these and other functions is provided below in connection with the discussion of the method for obtaining the optimal noise factors and optimal extrapolator to be used in quantum error mitigation techniques (e.g., zero noise extrapolation) for a given quantum circuit and quantum hardware.

Prior to the discussion of the method for obtaining the optimal noise factors and optimal extrapolator to be used in quantum error mitigation techniques (e.g., zero noise extrapolation) for a given quantum circuit and quantum hardware, a description of the hardware configuration of classical computer 102 (FIG. 1) is provided below in connection with FIG. 3.

Referring now to FIG. 3, in conjunction with FIG. 1, FIG. 3 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code 301 involved in performing the inventive methods, such as obtaining the optimal noise factors and optimal extrapolator to be used in quantum error mitigation techniques (e.g., zero noise extrapolation) for a given quantum circuit and quantum hardware. In addition to block 301, computing environment 300 includes, for example, classical computer 102, network 113, such as a wide area network (WAN), end user device (EUD) 302, remote server 303, public cloud 304, and private cloud 305. In this embodiment, classical computer 102 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically classical computer 102, to keep the presentation as simple as possible. Classical computer 102 may be located in a cloud, even though it is not shown in a cloud in FIG. 3. On the other hand, classical computer 102 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto classical computer 102 to cause a series of operational steps to be performed by processor set 306 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 308 and the other storage media discussed below. The program instructions, and associated data, are accessed by processor set 306 to control and direct performance of the inventive methods. In computing environment 300, at least some of the instructions for performing the inventive methods may be stored in block 301 in persistent storage 311.

Communication fabric 309 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 310 is located in a single package and is internal to classical computer 102, but, alternatively or additionally, the volatile memory may be distributed over multiple packages and/or located externally with respect to classical computer 102.

Persistent Storage 311 is any form of non-volatile storage for computers that is now known or to be developed in the future. The non-volatility of this storage means that the stored data is maintained regardless of whether power is being supplied to classical computer 102 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the inventive methods.

Peripheral device set 313 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows classical computer 102 to communicate with other computers through WAN 113. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the inventive methods can typically be downloaded to classical computer 102 from an external computer or external storage device through a network adapter card or network interface included in network module 317.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates classical computer 102), and may take any of the forms discussed above in connection with classical computer 102. EUD 302 typically receives helpful and useful data from the operations of classical computer 102. For example, in a hypothetical case where classical computer 102 is designed to provide a recommendation to an end user, this recommendation would typically be communicated from network module 317 of classical computer 102 through WAN 113 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to classical computer 102. Remote server 303 may be controlled and used by the same entity that operates classical computer 102. Remote server 303 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components discussed above in connection with FIG. 2 to obtain the optimal noise factors and optimal extrapolator to be used in quantum error mitigation techniques (e.g., zero noise extrapolation) for a given quantum circuit and quantum hardware. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for obtaining the optimal noise factors and optimal extrapolator to be used in quantum error mitigation techniques (e.g., zero noise extrapolation) for a given quantum circuit and quantum hardware, may be embodied in an application specific integrated circuit.

As stated above, current quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates. As a result, quantum error mitigation techniques have been developed. Quantum error mitigation refers to mitigating computation errors while keeping the hardware load to a minimum. That is, quantum error mitigation is a technique that reduces the effects of noise and error on measured observables. An example of a quantum error mitigation technique is the zero noise extrapolation technique. Zero noise extrapolation is a technique used in quantum computing to estimate the result of a quantum computation without noise by running the computation at different levels of added noise and then extrapolating the results to the “zero-noise” limit, effectively mitigating errors caused by the inherent noise in a quantum system. Such a technique utilizes parameters, such as noise factors and an extrapolator, to extrapolate the noisy results back to the zero-noise limit. Noise factors refer to the number of times the gates are folded, or in other words, repeated, to create a functionally equivalent quantum circuit which will be more noisy than the original quantum circuit due to the additional inserted gates. An extrapolator refers to a mathematical function used to estimate the ideal result of a quantum computation by fitting a curve through various expectation values obtained via the artificially amplified noise, i.e., the folded quantum circuits, and extrapolating to the zero-noise limit. Unfortunately, there is no well-defined protocol to select the optimal noise factors and extrapolator such that they obtain the extrapolated expectation value (estimated ideal expectation value of a quantum circuit) that is close to the ideal expectation value (expected value of an observable that would be obtained in a completely noise-free quantum system). As a result, selection of the optimal noise factors and extrapolator often depend on user experience and intuition. For example, one such technique runs the quantum error mitigation technique on randomized benchmarking quantum circuits and obtains the best set of noise factors and the best extrapolator to use for such quantum circuits. Such parameters may then be used for the quantum circuits of interest. Unfortunately, it is not guaranteed that such parameters, which are best suited for the randomized benchmarking quantum circuits, will also be the best parameters for any other quantum circuit. Furthermore, the noise factors are preselected from sets of noise factors which may not correspond to the optimal noise factors to be used in performing quantum error mitigation on a quantum circuit. Another technique in an attempt to obtain the optimal noise factors and optimal extrapolator to be used in quantum error mitigation techniques utilizes a heatmap which stores the best extrapolator for a given noise factor with varying number of qubits and error probability. Unfortunately, the noise factors are preselected from a predefined set which may not correspond to the optimal noise factors to be used in performing quantum error mitigation on a quantum circuit. Furthermore, the technique requires the storing of the heatmap as a lookup table. Such a lookup table should be stored for different circuit types, which may require a significant amount of storage overhead. Consequently, there is not currently a means for selecting the optimal noise factors and optimal extrapolator to be used in quantum error mitigation techniques (e.g., zero noise extrapolation) for a given quantum circuit and quantum hardware such that the obtained extrapolated expectation value is close to the ideal expectation value.

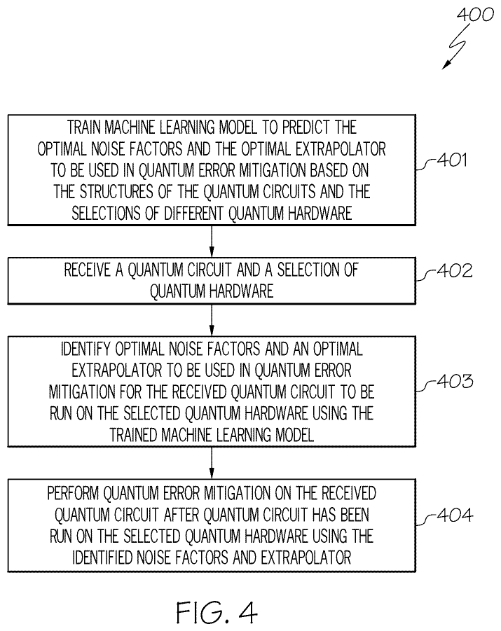

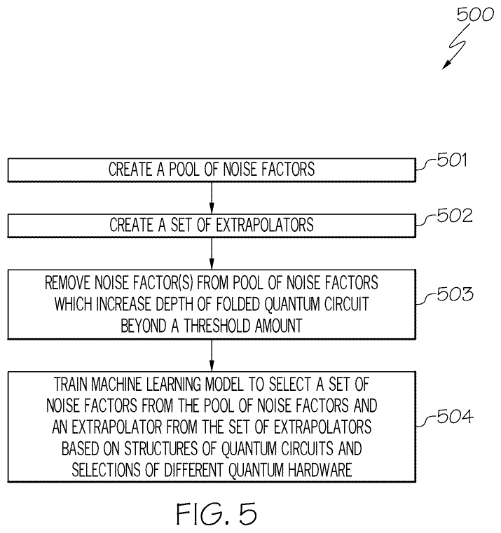

The embodiments of the present disclosure provide the means for selecting the optimal noise factors and optimal extrapolator to be used in quantum error mitigation techniques (e.g., zero noise extrapolation) for a given quantum circuit and quantum hardware such that the obtained extrapolated expectation value is close to the ideal expectation value using a reinforcement learning approach as discussed below in connection with FIGS. 4-5. FIG. 4 is a flowchart of a method for selecting the optimal noise factors and optimal extrapolator to be used in quantum error mitigation techniques (e.g., zero noise extrapolation) for a given quantum circuit and quantum hardware. FIG. 5 is a flowchart of a method for training the machine learning model to predict the optimal noise factors and the optimal extrapolator to be used in quantum error mitigation.

As discussed above, FIG. 4 is a flowchart of a method 400 for selecting the optimal noise factors and optimal extrapolator to be used in quantum error mitigation techniques (e.g., zero noise extrapolation) for a given quantum circuit and quantum hardware in accordance with an embodiment of the present disclosure.

Referring to FIG. 4, in conjunction with FIGS. 1-3, in step 401, machine learning engine 201 of classical computer 102 trains a machine learning model to predict the optimal noise factors and optimal extrapolator to be used in quantum error mitigation (e.g., zero noise extrapolation, probabilistic error amplification) based on the quantum circuits, such as the structures of the quantum circuits, and the selections of different quantum hardware (e.g., noise profile of the selected quantum hardware, which may include data, such as calibration data, etc.).

In one embodiment, machine learning engine 201 trains the machine learning model to predict the optimal noise factors and optimal extrapolator to be used in quantum error mitigation using a reinforcement learning approach as discussed below in connection with FIG. 5.

FIG. 5 is a flowchart of a method 500 for training the machine learning model to predict the optimal noise factors and the optimal extrapolator to be used in quantum error mitigation in accordance with an embodiment of the present disclosure.

Referring to FIG. 5, in conjunction with FIGS. 1-4, in step 501, machine learning engine 201 of classical computer 102 creates a pool of noise factors.

As stated above, a noise factor, as used herein, refers to the number of times a quantum circuit is folded, such as by repeating a certain gate sequence several times, which effectively increases the noise level by repeating parts of the quantum circuit. A pool of noise factors, as used herein, refers to a collection of different noise factors, each corresponding to a distinct “folding” or repetition pattern within the quantum circuit.

In one embodiment, machine learning engine 201 obtains such a pool of noise factors from an expert, which identifies all possible sources of noise within a quantum computing hardware considering factors, such as, the physical environment, control electronics, the design of the qubits, etc., thereby effectively taking into account the “folding” effect of repeated gate sequences. Furthermore, the types of noise are categorized based on their behavior, such as bit-flip noise (where a qubit randomly flips between states), phase-flip noise (where the phase of a qubit changes), etc. Additionally, each noise source may be represented using mathematical models, which may involve probability distributions and quantum operations, to describe how the noise source affects the state of the qubit.

In one embodiment, machine learning engine 201 creates such a pool of noise factors by characterizing the dominant noise sources on various quantum hardware. In one embodiment, machine learning engine 201 characterizes the dominant noise sources on various quantum hardware using various software tools, such as, but are not limited to, Qiskit® Ignis, Cirq®, Amazon Braket®, HQS® Noise App from HQS Quantum Simulations®, etc. In one embodiment, machine learning engine 201 then systematically generates a set of quantum circuits that amplify different combinations of these noise types to varying degrees, such as by manipulating gate durations, adding additional gates to introduce specific noise, or utilizing a noise model to simulate different noise scenarios. In one embodiment, machine learning engine 201 generates a set of quantum circuits that amplify different combinations of these noise types to varying degrees using various software tools, such as, but are not limited to, Qiskit®, Cirq®, PennyLane®, Amazon Braket®, etc.

In step 502, machine learning engine 201 of classical computer 102 creates a set of extrapolators (extrapolation functions).

As discussed above, an extrapolator, as used herein, refers to a mathematical function used to estimate the ideal result of a quantum computation by fitting a curve through various expectation values obtained via the artificially amplified noise, i.e., the folded quantum circuits, and extrapolating to the zero-noise limit. Examples of extrapolators include, but are not limited to, linear, any degree of polynomial (e.g., quadratic polynomial), exponential, etc.

In one embodiment, machine learning engine 201 creates a set of extrapolators by defining a family of extrapolation functions that represent different noise levels. In one embodiment, such a family of extrapolation functions may be defined by scaling the noise in a quantum circuit and then fitting a curve to the results obtained at each noise level to extrapolate to the zero-noise limit.

In one embodiment, machine learning engine 201 scales the noise in a quantum circuit by applying a scaling factor to the noise parameters or using a “folding” technique to replicate noise multiple times. The “folding” technique, as used herein, refers to repeatedly running the quantum circuit and its inverse thereby amplifying the noise present within the circuit by essentially “folding” the noise onto itself allowing for better characterization and extrapolation to a zero-noise scenario.

In one embodiment, after scaling the noise in a quantum circuit, machine learning engine 201 selects a family of extrapolation functions (e.g., quadratic polynomial, linear, etc.) to fit the noisy measurements at different noise levels. Machine learning engine 201 may then generate noisy data by running the quantum circuit at different noise levels using a chosen scaling method thereby collecting the measured expectation values at each level.

In one embodiment, machine learning engine 201 fits the curve to the results obtained at each noise level to extrapolate to the zero-noise limit. For example, machine learning engine 201 may utilize the least squares regression algorithm to fit the noisy measurements to the extrapolation function thereby obtaining the best fit parameters for each noise level. Machine learning engine 201 may then evaluate each extrapolation function at the zero-noise point to obtain the extrapolated noise-free expectation value.

In step 503, machine learning engine 201 removes the noise factor(s) from the pool of noise factors which increase the depth of a folded quantum circuit beyond a threshold amount, which may be user-designated.

As discussed above, in one embodiment, machine learning engine 201 performs a pre-screening on the pool of noise factors in order to reduce the number of noise factors in the pool so as to ensure that the size of the pool of noise factors is finite and ensure that the signal can be retrieved from the folded quantum circuit. The folded quantum circuit, as used herein, refers to the quantum circuit that was mirrored or “folded back on itself” by repeating its operations in reverse order using the “circuit folding” technique discussed above.

In one embodiment, machine learning engine 201 pre-screens the pool of noise factors for each input quantum circuit to create a finite pool P of noise factors. For example, for a given quantum hardware, the depth of the folded quantum circuits is restricted such that d_{2q}·t_{2q}≤ƒ·T₁, where d_{2q} equals the 2-qubit depth of the quantum circuit, t_{2q} equals the execution time of a 2-qubit gate, f is the fidelity of the quantum gate, T₁ represents the relaxation time of the qubit, and 0<ƒ≤1, where 1 indicates perfect fidelity. In one embodiment, machine learning engine 201 may then remove those noise factors from the pool of noise factors with values that do not satisfy such an inequality.

In step 504, machine learning engine 201 of classical computer 102 trains the machine learning model, such as via reinforcement learning, to select a set of noise factors from the pool of noise factors and select an extrapolator from the set of extrapolators based on the structures of quantum circuits and the selections of different quantum hardware (e.g., noise profile of the selected quantum hardware, which may include data, such as calibration data, etc.).

As stated above, the structure of a quantum circuit, as used herein, refers to the model for quantum computations, which is represented as a sequence of quantum gates applied to qubits. Examples of the structure of the quantum circuit used in training the machine learning model include, but are not limited to, the number of qubits, number of 2-qubit gates, 2-qubit depth, etc.

In one embodiment, the trained machine learning model is a reinforcement learning model. In one embodiment, machine learning engine 201 trains the machine learning model to calculate an extrapolated expectation value, where a reward is granted to a reinforcement learning agent proportional to a distance from the extrapolated expectation value to an ideal expectation value. The extrapolated expectation value, as used herein, refers to the estimated ideal expectation value of the quantum circuit, which may be computed using the selected noise factors and a selected extrapolator. The ideal expectation value, as used herein, refers to the expected value of an observable that would be obtained in a completely noise-free quantum system.

In one embodiment, machine learning engine 201 obtains the ideal expectation value by Cliffordizing the quantum circuit used in training the machine learning model, where the ideal expectation value is calculated from the Cliffordized quantum circuit. Cliffordizing, as used herein, refers to rewriting the quantum circuit so that it only contains Clifford gates.

In one embodiment, machine learning engine 201 calculates the ideal expectation value from the Cliffordized quantum circuit by decomposing the desired observable into a sum of Pauli operators. The Cliffordized quantum circuit is then simulated by expressing the evolved operator as a linear combination of Pauli strings. The ideal expectation value is then calculated by taking the appropriate weighted sum of the Pauli string expectation values.

Alternatively, in one embodiment, machine learning engine 201 obtains the ideal expectation value by mirroring the quantum circuit used in training the machine learning model. “Mirroring,” as used herein, refers to creating a new quantum circuit by essentially reversing the operations of the original quantum circuit thereby effectively performing the same calculations in reverse order. In one embodiment, machine learning engine 201 runs the original quantum circuit forward and then runs the mirrored quantum circuit backward applying the desired observable operator in between. The resulting state is then measured to obtain the ideal expectation value.

Machine learning engine 201 utilizes various software tools for obtaining the ideal expectation value in the manners discussed above, including, but are not limited to, Qiskit®, Cirq®, PyQuil, QSim, ProjectQ, PennyLane®, etc.

In one embodiment, machine learning engine 201 trains the machine learning model to select a set of noise factors from the pool of noise factors and select an extrapolator from the set of extrapolators based on the structures of quantum circuits and selections of different quantum hardware using reinforcement learning using the following state space, action set and reward. The state space, as used herein, refers to the set of all possible states that an agent (reinforcement learning agent, which is a software program that learns to make decisions by interacting with its environment through trial and error using a system of rewards and punishments to gradually improve its actions and achieve a specific goal) can be in within a given environment.

In one embodiment, the state space S includes a collection of a set of pools of noise factors P′⊆P. Furthermore, in one embodiment, the state space S includes a set of extrapolators E, or a predefined extrapolator e.

In one embodiment, the action set A, corresponding to the possible actions that the reinforcement learning agent can perform in a given environment, include choosing a pool of noise factors from P′ and updating the extrapolator if required in the next fold in the folded quantum circuit. Furthermore, an action could be to select λ∈P and e∈E at each step, where λ corresponds to the number of folds in the folded quantum circuit.

In one embodiment, the minimum number of folds is determined by the degree of the extrapolator. In one embodiment, the maximum number of folds that can be used can be enforced from the allowed quantum overhead for performing quantum error mitigation, which may be user-designated or a default value.

In one embodiment, once the λs are selected, extrapolation can be performed in a sorted order.

In one embodiment, the reward, which corresponds to a numerical value that the reinforcement learning agent receives after taking an action in a specific state of an environment, corresponds to (ideal-predicted)²−ƒ(N) at the end of an episode, where N is the number of λ values selected. In one embodiment, the function f can be chosen to increase with N to limit the number of foldings.

In one embodiment, machine learning engine 201 trains the machine learning model (e.g., reinforcement learning model) to predict the best noise factors upon being provided the extrapolator as opposed to predicting the optimal noise factors and the optimal extrapolator based on the structure of the quantum circuit (e.g., number of qubits, number of 2-qubit gates, 2-qubit depth, etc.) and the selected quantum hardware (e.g., noise profile of the selected quantum hardware, which may include data, such as calibration data, etc.). Such predicted noise factors and extrapolator correspond to the optimal noise factors and optimal extrapolator as discussed herein.

In one embodiment, machine learning engine 201 trains the machine learning model to predict the optimal noise factors for the provided extrapolator, where a reward is granted to a reinforcement learning agent proportional to a distance from the extrapolated expectation value (computed using the selected noise factors and the provided extrapolator) to an ideal expectation value.

Returning now to FIG. 4, in conjunction with FIGS. 1-3 and 5, in step 402, prediction engine 202 of classical computer 102 receives a quantum circuit, such as the structure of a quantum circuit (e.g., number of qubits, number of 2-qubit gates, 2-qubit depth, etc.) for which to perform quantum error mitigation as well as receives a selection of quantum hardware (e.g., noise profile of the selected quantum hardware, which may include data, such as calibration data, etc.).

As discussed above, prediction engine 202 is configured to identify the optimal noise factors and the optimal extrapolator to be used in quantum error mitigation for a received quantum circuit (e.g., number of qubits, number of 2-qubit gates, 2-qubit depth, etc.) to be run on a selected quantum hardware (e.g., noise profile of the selected quantum hardware, which may include data, such as calibration data, etc.) using the trained machine learning model.

In one embodiment, prediction engine 202 receives a quantum circuit, such as the structure of a quantum circuit (e.g., number of qubits, number of 2-qubit gates, 2-qubit depth, etc.) for which to perform quantum error mitigation. In one embodiment, such a quantum circuit is provided to prediction engine 202 via the user interface of classical computer 102. In one embodiment, the quantum circuit, such as the structure of the quantum circuit, is inputted to prediction engine 202 via various software tools, including, but are not limited to, Qiskit®, IBM Quantum® Platform, Intel® Quantum Simulator, etc.

In one embodiment, prediction engine 202 receives a selected quantum hardware (e.g., noise profile of the selected quantum hardware, which may include data, such as calibration data, etc.), such as a quantum hardware selected from a menu of various types of quantum hardware. In one embodiment, such a menu of various types of quantum hardware is displayed to a user via the user interface of classical computer 102. The user may then select one of the types of quantum hardware being displayed to the user, such as via a mouse, tapping on a touchscreen, voice commands, keyboard, etc. In one embodiment, the selected quantum hardware (noise profile of the selected quantum hardware, which may include data, such as calibration data, etc.) is inputted to prediction engine 202 via various software tools, including, but are not limited to, Qiskit®, IBM Quantum® Platform, Intel® Quantum Simulator, etc.

In step 403, prediction engine 202 of classical computer 102 identifies the optimal noise factors and the optimal extrapolator to be used in quantum error mitigation for the received quantum circuit to be run on the selected quantum hardware using the trained machine learning model as discussed above based on the provided structure of the quantum circuit and the selected quantum hardware.

As stated above, the term “optimal,” as used herein, refers to those noise factors and extrapolator to be used for the quantum error mitigation technique (e.g., zero noise extrapolation), where such noise factors and extrapolator provide the extrapolated expectation value that is close to the ideal expectation value.

Alternatively, in one embodiment, prediction engine 202 receives an extrapolator. An extrapolator, as used herein, refers to a mathematical function used to estimate the ideal result of a quantum computation by fitting a curve through various expectation values obtained via the artificially amplified noise, i.e., the folded quantum circuits, and extrapolating to the zero-noise limit. Examples of extrapolators include, but are not limited to, linear, any degree of polynomial (e.g., quadratic polynomial), exponential, etc.

In one embodiment, prediction engine 202 receives the extrapolator for which to perform quantum error mitigation. In one embodiment, the extrapolator is provided to prediction engine 202 via the user interface of classical computer 102. In one embodiment, the extrapolator is inputted to prediction engine 202 via various software tools, including, but are not limited to, Qiskit®, IBM Quantum® Platform, Intel® Quantum Simulator, etc.

In such an embodiment, prediction engine 202 predicts the best noise factors for that extrapolator using the trained machine learning model as discussed above. Such noise factors and extrapolator correspond to the optimal noise factors and optimal extrapolator discussed herein.

In step 404, quantum error mitigation module 203 of classical computer 102 performs quantum error mitigation on the quantum circuit, such as the received quantum circuit, after the quantum circuit has been run on the selected quantum hardware using the identified optimal noise factors and optimal extrapolator.

As discussed above, quantum error mitigation, as used herein, refers to mitigating computation errors while keeping the hardware load to a minimum. That is, quantum error mitigation is a technique that reduces the effects of noise and error on measured observables.

An example of a quantum error mitigation technique is the zero noise extrapolation technique. The zero noise extrapolation, as used herein, is a technique used in quantum computing to estimate the result of a quantum computation without noise by running the computation at different levels of added noise and then extrapolating the results to the “zero-noise” limit, effectively mitigating errors caused by the inherent noise in a quantum system.

Another example of a quantum error mitigation technique is the probabilistic error amplification. Probabilistic error amplification, as used herein, is a technique which introduces controlled noise to a quantum circuit to amplify existing errors. The amplified noise data is then used in conjunction with zero noise extrapolation, where the results from different noise levels are extrapolated to estimate what the results would be in a completely noise-free scenario.

Quantum error mitigation module 203 utilizes various software tools for performing quantum error mitigation in the manner discussed above, including, but are not limited to, Mitiq, Qiskit®, Cirq®, PyQuil®, etc.

In this manner, the optimal noise factors and optimal extrapolator to be used in quantum error mitigation techniques (e.g., zero noise extrapolation) for a given quantum circuit and quantum hardware such that the obtained extrapolated expectation value is close to the ideal expectation value can be obtained. Such optimal noise factors are not obtained from a search space that is restricted to a predefined list of noise factors. Furthermore, embodiments of the present disclosure do not require the storing of a heatmap as a lookup table thereby avoiding such a storage overhead.

Furthermore, the principles of the present disclosure improve the technology or technical field involving quantum error mitigation.

As discussed above, current quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates. As a result, quantum error mitigation techniques have been developed. Quantum error mitigation refers to mitigating computation errors while keeping the hardware load to a minimum. That is, quantum error mitigation is a technique that reduces the effects of noise and error on measured observables. An example of a quantum error mitigation technique is the zero noise extrapolation technique. Zero noise extrapolation is a technique used in quantum computing to estimate the result of a quantum computation without noise by running the computation at different levels of added noise and then extrapolating the results to the “zero-noise” limit, effectively mitigating errors caused by the inherent noise in a quantum system. Such a technique utilizes parameters, such as noise factors and an extrapolator, to extrapolate the noisy results back to the zero-noise limit. Noise factors refer to the number of times the gates are folded, or in other words, repeated, to create a functionally equivalent quantum circuit which will be more noisy than the original quantum circuit due to the additional inserted gates. An extrapolator refers to a mathematical function used to estimate the ideal result of a quantum computation by fitting a curve through various expectation values obtained via the artificially amplified noise, i.e., the folded quantum circuits, and extrapolating to the zero-noise limit. Unfortunately, there is no well-defined protocol to select the optimal noise factors and extrapolator such that they obtain the extrapolated expectation value (estimated ideal expectation value of a quantum circuit) that is close to the ideal expectation value (expected value of an observable that would be obtained in a completely noise-free quantum system). As a result, selection of the optimal noise factors and extrapolator often depend on user experience and intuition. For example, one such technique runs the quantum error mitigation technique on randomized benchmarking quantum circuits and obtains the best set of noise factors and the best extrapolator to use for such quantum circuits. Such parameters may then be used for the quantum circuits of interest. Unfortunately, it is not guaranteed that such parameters, which are best suited for the randomized benchmarking quantum circuits, will also be the best parameters for any other quantum circuit. Furthermore, the noise factors are preselected from sets of noise factors which may not correspond to the optimal noise factors to be used in performing quantum error mitigation on a quantum circuit. Another technique in an attempt to obtain the optimal noise factors and optimal extrapolator to be used in quantum error mitigation techniques utilizes a heatmap which stores the best extrapolator for a given noise factor with varying number of qubits and error probability. Unfortunately, the noise factors are preselected from a predefined set which may not correspond to the optimal noise factors to be used in performing quantum error mitigation on a quantum circuit. Furthermore, the technique requires the storing of the heatmap as a lookup table. Such a lookup table should be stored for different circuit types, which may require a significant amount of storage overhead. Consequently, there is not currently a means for selecting the optimal noise factors and optimal extrapolator to be used in quantum error mitigation techniques (e.g., zero noise extrapolation) for a given quantum circuit and quantum hardware such that the obtained extrapolated expectation value is close to the ideal expectation value.

Embodiments of the present disclosure improve such technology by training a machine learning model to predict the optimal noise factors and optimal extrapolator to be used in quantum error mitigation (e.g., zero noise extrapolation, probabilistic error amplification) based on the quantum circuits, such as the structures of the quantum circuits, and the selections of different quantum hardware (e.g., noise profile of the selected quantum hardware, which may include data, such as calibration data, etc.). In one embodiment, such a machine learning model is trained using a reinforcement learning approach. Based on the received structure of the quantum circuit (e.g., number of qubits, number of 2-qubit gates, 2-qubit depth, etc.) and the selected quantum hardware (e.g., noise profile of the selected quantum hardware, which may include data, such as calibration data, etc.), the optimal noise factors and the optimal extrapolator to be used in quantum error mitigation for the received quantum circuit to be run on the selected quantum hardware are identified using the trained machine learning model. The term “optimal,” as used herein, refers to those noise factors and extrapolator to be used for the quantum error mitigation technique (e.g., zero noise extrapolation), where such noise factors and extrapolator provide the extrapolated expectation value that is close to the ideal expectation value. Quantum error mitigation is then performed on the quantum circuit, such as the received quantum circuit, after the quantum circuit has been run on the selected quantum hardware using the identified optimal noise factors and optimal extrapolator. In this manner, the optimal noise factors and optimal extrapolator to be used in quantum error mitigation techniques (e.g., zero noise extrapolation) for a given quantum circuit and quantum hardware such that the obtained extrapolated expectation value is close to the ideal expectation value can be obtained. Furthermore, in this manner, there is an improvement in the technical field involving quantum error mitigation.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for performing quantum error mitigation, the method comprising:
training a machine learning model to predict noise factors and an extrapolator to be used in said quantum error mitigation based on structures of quantum circuits and selections of different quantum hardware;
receiving a quantum circuit and a selection of quantum hardware;
identifying noise factors and an extrapolator to be used in said quantum error mitigation for said quantum circuit using said trained machine learning model; and
performing said quantum error mitigation on said quantum circuit after said quantum circuit has been run on said quantum hardware using said identified noise factors and said extrapolator.

2. The method as recited in claim 1, wherein said quantum error mitigation comprises zero noise extrapolation.

3. The method as recited in claim 1, wherein said quantum error mitigation comprises probabilistic error amplification.

4. The method as recited in claim 1 further comprising:
creating a pool of noise factors;
creating a set of extrapolators; and
training said machine learning model to select a set of noise factors from said pool of noise factors and select an extrapolator from said set of extrapolators to be used in said quantum error mitigation based on said structures of quantum circuits and said selections of different quantum hardware.

5. The method as recited in claim 4 further comprising:
removing one or more noise factors from said pool of noise factors which increase depth of a folded quantum circuit beyond a threshold amount.

6. The method as recited in claim 1, wherein said trained machine learning model is a reinforcement learning model, wherein said trained machine learning model calculates an extrapolated expectation value, wherein a reward is granted to a reinforcement learning agent proportional to a distance from said extrapolated expectation value to an ideal expectation value.

7. The method as recited in claim 6, wherein said ideal expectation value is obtained by Cliffordizing a quantum circuit used in training said machine learning model or mirroring said quantum circuit used in training said machine learning model.

8. A computer program product for performing quantum error mitigation, the computer program product comprising one or more computer readable storage mediums having program code embodied therewith, the program code comprising programming instructions for:
training a machine learning model to predict noise factors and an extrapolator to be used in said quantum error mitigation based on structures of quantum circuits and selections of different quantum hardware;
receiving a quantum circuit and a selection of quantum hardware;
identifying noise factors and an extrapolator to be used in said quantum error mitigation for said quantum circuit using said trained machine learning model; and
performing said quantum error mitigation on said quantum circuit after said quantum circuit has been run on said quantum hardware using said identified noise factors and said extrapolator.

9. The computer program product as recited in claim 8, wherein said quantum error mitigation comprises zero noise extrapolation.

10. The computer program product as recited in claim 8, wherein said quantum error mitigation comprises probabilistic error amplification.

11. The computer program product as recited in claim 8, wherein the program code further comprises the programming instructions for:
creating a pool of noise factors;
creating a set of extrapolators; and
training said machine learning model to select a set of noise factors from said pool of noise factors and select an extrapolator from said set of extrapolators to be used in said quantum error mitigation based on said structures of quantum circuits and said selections of different quantum hardware.

12. The computer program product as recited in claim 11, wherein the program code further comprises the programming instructions for:
removing one or more noise factors from said pool of noise factors which increase depth of a folded quantum circuit beyond a threshold amount.

13. The computer program product as recited in claim 8, wherein said trained machine learning model is a reinforcement learning model, wherein said trained machine learning model calculates an extrapolated expectation value, wherein a reward is granted to a reinforcement learning agent proportional to a distance from said extrapolated expectation value to an ideal expectation value.

14. The computer program product as recited in claim 13, wherein said ideal expectation value is obtained by Cliffordizing a quantum circuit used in training said machine learning model or mirroring said quantum circuit used in training said machine learning model.

15. A system, comprising:
a memory for storing a computer program for performing quantum error mitigation; and
a processor connected to said memory, wherein said processor is configured to execute program instructions of the computer program comprising:
training a machine learning model to predict noise factors and an extrapolator to be used in said quantum error mitigation based on structures of quantum circuits and selections of different quantum hardware;
receiving a quantum circuit and a selection of quantum hardware;
identifying noise factors and an extrapolator to be used in said quantum error mitigation for said quantum circuit using said trained machine learning model; and
performing said quantum error mitigation on said quantum circuit after said quantum circuit has been run on said quantum hardware using said identified noise factors and said extrapolator.

16. The system as recited in claim 15, wherein said quantum error mitigation comprises zero noise extrapolation.

17. The system as recited in claim 15, wherein said quantum error mitigation comprises probabilistic error amplification.

18. The system as recited in claim 15, wherein the program instructions of the computer program further comprise:
creating a pool of noise factors;
creating a set of extrapolators; and
training said machine learning model to select a set of noise factors from said pool of noise factors and select an extrapolator from said set of extrapolators to be used in said quantum error mitigation based on said structures of quantum circuits and said selections of different quantum hardware.

19. The system as recited in claim 18, wherein the program instructions of the computer program further comprise:
removing one or more noise factors from said pool of noise factors which increase depth of a folded quantum circuit beyond a threshold amount.

20. The system as recited in claim 15, wherein said trained machine learning model is a reinforcement learning model, wherein said trained machine learning model calculates an extrapolated expectation value, wherein a reward is granted to a reinforcement learning agent proportional to a distance from said extrapolated expectation value to an ideal expectation value.
